(19) United States
(12) Patent Application Publication
(10) Pub. No.: US 2009/0322889 A1
(43) Pub. Date: Dec. 31, 2009

(54) METHOD AND APPARATUS FOR ILLUMINATING USERS OF VIDEO COMMUNICATION DEVICES

(75) Inventors: Gregory KUJAWA, Saint Charles, IL (US); Bei Tang, Palatine, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/147,894

(22) Filed: Jun. 27, 2008

(51) Int. Cl. H04N 5/225; G09G 5/10

(52) U.S. Cl. 348/207.99; 345/690; 348/E05.024

(57) ABSTRACT

A method for illuminating a user of a video communication device is disclosed. The method may include capturing a video image using the video communication device, determining video image quality factor values based on the captured video image, determining if the video image quality factor values exceed at least one threshold value, wherein if the video image quality factor values are determined not to exceed at least one threshold value, adjusting at least one display property of at least one unused portion of the user's display based on the determined video image quality factor values and the at least one threshold value, wherein the at least one unused portion of the user's display is not being used to present images to the user, and capturing the video image using the adjusted display properties for presentation to another party in video communication with the user.

### BACKGROUND OF THE DISCLOSED EMBODIMENTS

1. Field of the Disclosure

The disclosure relates to illumination techniques for video communication devices.

2. Introduction

In any video capturing, proper lighting is always essential to correctly capture the desired subject matter. In professional videography, additional light sources are set up and used in most cases and aimed at the desired subjects to be captured. In the case of in-home video communications where a television or monitor is being used as the viewing source and is located in a typical family room or living room, for example, these rooms usually only have dim illumination sources, and those sources may not be located in a manner to properly illuminate the subject.

### SUMMARY OF THE DISCLOSED EMBODIMENTS

A method for illuminating a user of a video communication device is disclosed. The method may include capturing a video image using the video communication device, determining video image quality factor values based on the captured video image, determining if the video image quality factor values exceed at least one threshold value, wherein if the video image quality factor values are determined not to exceed at least one threshold value, adjusting at least one display property of at least one unused portion of the user's display based on the determined video image quality factor values and the at least one threshold value, wherein the at least one unused portion of the user's display is not being used to present images to the user, and capturing the video image using the adjusted display properties for presentation to another party in video communication with the user.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is a diagram of an exemplary video communication device in accordance with a possible embodiment of the disclosure;

FIG. 2 is a diagram of an exemplary video communication device with multiple video images presented on the display in accordance with a possible embodiment of the disclosure;

FIG. 3 is an exemplary block diagram of a video communication device in accordance with a possible embodiment of the disclosure; and

FIG. 4 is an exemplary flowchart illustrating a video communication illumination process in accordance with one possible embodiment of the disclosure.

### DETAILED DESCRIPTION OF THE DISCLOSED EMBODIMENTS

Additional features and advantages of the disclosed embodiments will be set forth in the description which follows, and in part will be obvious from the description, or may be learned by practice of the disclosed embodiments. The features and advantages of the disclosed embodiments may be realized and obtained by means of the instruments and combinations particularly pointed out in the appended claims.

Various embodiments of the disclosed embodiments are discussed in detail below. While specific implementations are discussed, it should be understood that this is done for illustration purposes only. A person skilled in the relevant art will recognize that other components and configurations may be used without parting from the spirit and scope of the disclosed embodiments.

The disclosed embodiments may comprise a variety of embodiments, such as a method and apparatus and other embodiments that relate to the basic concepts of the disclosed embodiments. The disclosed embodiments may concern the use of a video display as a possible illumination source in video communication. Implementation of the process may be designed such that unused portion of the display (i.e., background areas of non-active windows, or window frames of existing windows) may be changed to another color (e.g., white, or some other adequate color or pattern of colors) to properly illuminate the subject viewing the video display.

Depending on the distance the subject matter is away from the display, the color or pattern may change to properly illuminate the subject matter. This color or pattern of colors may also change as the active windows change what they are displaying and thus project different lighting conditions on the subject matter. A feedback loop (monitoring process) may be used to properly analyze the captured subject matter on a frame-by-frame basis, for example, at the near end and then correct the lighting on the display to properly illuminate the subject matter.

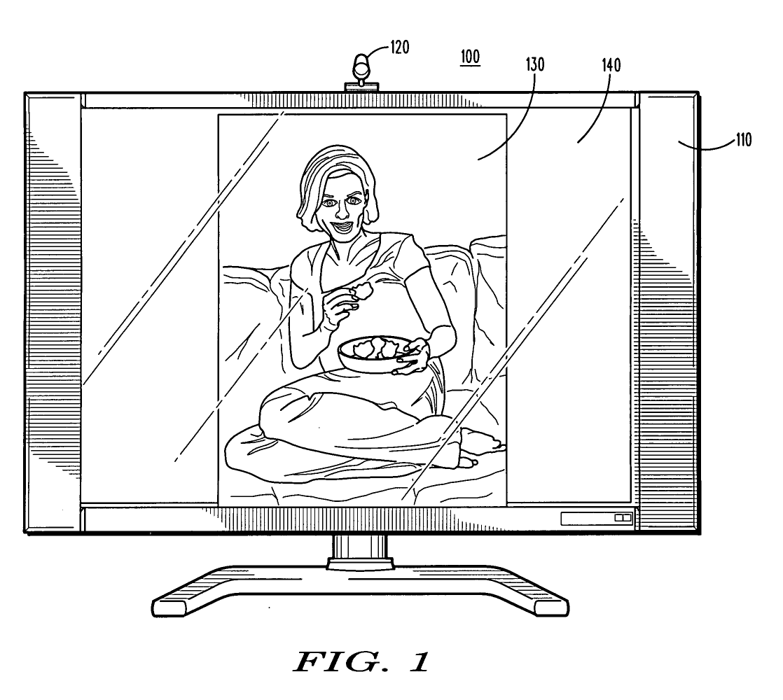

FIG. 1 is a diagram of an exemplary video communication device 100 in accordance with a possible embodiment of the disclosed embodiments. The video communication device 100 may include a display unit 110 (or “display”), a camera unit 120 (or “camera”), at least one video image 130, and at least one unused display area 140.

The video communication device 100 may be a computer, a server, a telephone, a set top box, a television, a personal digital assistant, or combinations of the above, for example. Although only one video communication device 100 is shown this is merely illustrative. There may be any number of video communication devices 100 or individual components of the video communication device 100 which in combination perform the claimed functions disclosed herein. The video communication device 100 may also be incorporated into a camera, a display, or other component of (or attachment to) a system that enables video communications.

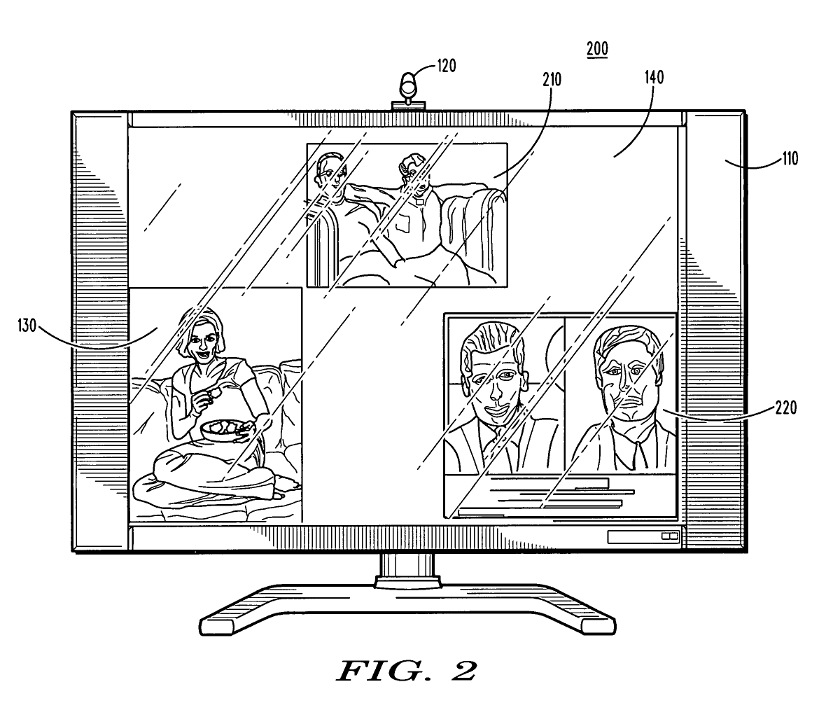

The display unit 110 may be any display that may display video (or video images) for video communications, such as a computer monitor, television monitor, telephone display, personal digital assistant (PDA) display, etc., for example. Video image 130 may be at least one video image of a user, a third party, or other subject that may be communicating or being presented to another party, for example. However, as shown in FIG. 2 and discussed below, the number of video images displayed may vary in accordance with the disclosed embodiments.

The camera unit 120 may be any camera that may capture and provide video images 130 to a display, for example. In addition, the camera unit 120 may be a stand alone camera connected to a display unit 110 of the video communication device 100, or it may be integrated into the display unit 110 of video communication device 100, for example.

The unused display areas 140 may be any number, shape, or size, depending on the size, number and shape of the at least one video image 130, for example.

FIG. 2 is a diagram of an exemplary video communication device 100 with multiple video images 130, 210, 220 presented on the display unit 110 in accordance with a possible disclosed embodiment. The video images 130, 210, 220 may be any combination of video images of the user, at least one party communicating with the user, a television program, DVD images, a static image (such as a picture or wallpaper), etc., for example. Although three video images 130, 210, 220 are shown, there may be any number of video images on the display unit 110 at any one time. As such, the unused display areas 140 may be located together or on different areas of the display screen, for example.

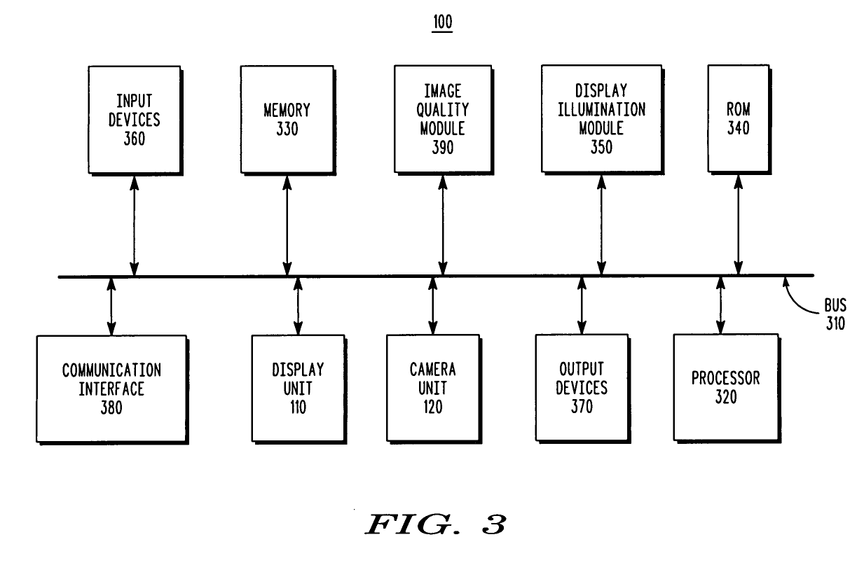

FIG. 3 is an exemplary block diagram of a video communication device 100 in accordance with a possible disclosed embodiment. The video communication device 100 may include a bus 310, processor 320, memory 330, read only memory (ROM 340, display illumination module 350, input devices 360, output devices 370, communication interface 380 and image quality module 390. The video communication device 100 may also include a display unit 110 and a camera unit 120, as shown in FIGS. 1 and 2, for example, which are discussed above.

Bus 310 may permit communication among the components of the video communication device 100. Processor 320 may include at least one conventional processor or microprocessor that interprets and executes instructions. Memory 330 may be a random access memory (RAM) or another type of dynamic storage device that stores information and instructions for execution by processor 320.

Communication interface 380 may include any mechanism that facilitates communication via a network. For example, communication interface 380 may include a modem. Alternatively, communication interface 380 may include other mechanisms for assisting in communications with other devices or systems.

ROM 340 may include a conventional ROM device or another type of static storage device that stores static information and instructions for processor 320. A storage device may augment the ROM 340 and may include any type of storage media, such as, for example, magnetic or optical recording media and their corresponding drives.

Input devices 360 may include at least one conventional mechanism that permits a user to input information to the video communication device 100, such as a keyboard, a mouse, a pen, a voice recognition device, or touchpad, buttons, for example. Output devices 370 may include at least one conventional mechanism that outputs information to the user, including a display, a printer, a copier, a scanner, a multi-function device, at least one speaker, or a medium, such as a memory, or a magnetic or optical disk and a corresponding disk drive.

The video communication device 100 may perform such functions in response to processor 320 by executing sequences of instructions contained in a computer-readable medium, such as, for example, memory 330. Such instructions may be read into memory 330 from another computer-readable medium, such as a storage device or from a separate device via communication interface 380.

Image quality module 390 may determine the video output quality from the camera unit or the display unit, for example. By analyzing the video image content, video image quality factor values are determined. The video image quality factor values may include video image average brightness, color gains, noise level, etc., for example.

The video communication device 100 illustrated in FIGS. 1-3 and the related discussion are intended to provide a brief, general description of a suitable communication and processing environment in which the invention may be implemented. Although not required, the invention will be described, at least in part, in the general context of computer-executable instructions, such as program modules being executed by the video communication device 100.

Generally, program modules include routine programs, objects, components, data structures, etc., that perform particular tasks or implement particular abstract data types. Moreover, those skilled in the art will appreciate that other embodiments of the invention may be practiced in communication network environments with many types of communication equipment and computer system configurations, including personal computers, hand-held devices, multi-processor systems, microprocessor-based or programmable consumer electronics, and the like.

Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

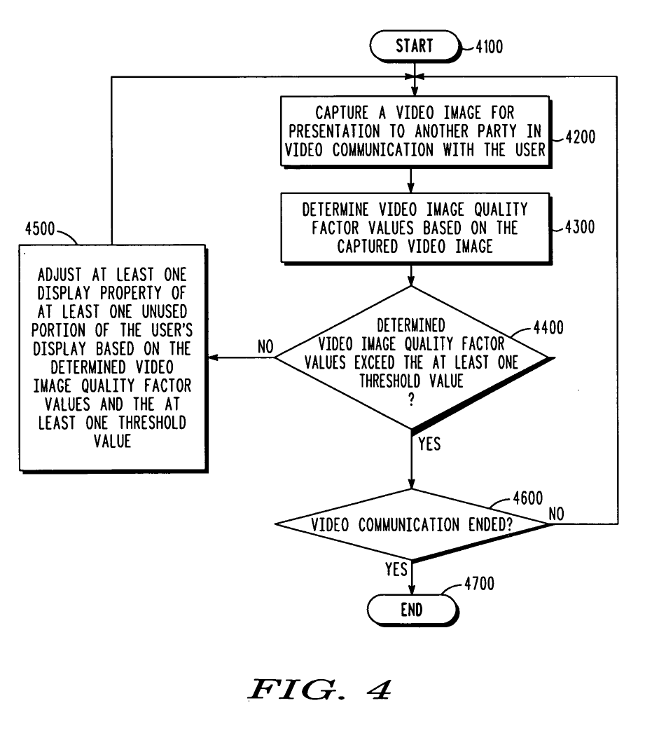

For illustrative purposes, the operation of the video communication device 100, the display illumination module 350, and the video communication illumination process are described in FIG. 4 in relation to the diagrams shown in FIGS. 1-3.

FIG. 4 is an exemplary flowchart illustrating a possible video communication illumination process in accordance with one possible disclosed embodiment. The process begins at step 4100 and continues to step 4200 where the camera unit 120 may capture a video image (or video image content) for presentation to another party in video communication with the user, for example.

At step 4300, the image quality module 390 may determine video image quality factor values based on the captured video image from the camera unit 120. The video image quality factor values may include video image average brightness, color gains, noise level, etc., for example.

At step 4400, the display illumination module 350 may determine if the video image quality factor values exceed at least one threshold value. The threshold values may be determined (or predetermined) by the user or the manufacturer, for example, in order to provide the best possible video image to a video communication recipient. If at step 4400, the display illumination module 350 determines that the video image quality factor values do not to exceed at least one threshold value, then at step 4500, the display illumination module 350 may adjust at least one display property of at least one unused portion of the user's display unit 110 based on the determined video image quality factor values and the at least one threshold value.

The display properties of the unused portions of the video display unit 110 may include intensity, contrast, brightness, color, etc., for example. As such, if the display illumination module 350 determines that the brightness value does not exceed the brightness threshold value, the display illumination module 350 may adjust the at least one display property of at least one unused portion of the user's display unit 110 to increase the brightness value to exceed the threshold. The process then returns to step 4200.

If at step 4400, the display illumination module 350 determines that the video image quality factor values exceed the at least one threshold value, then at step 4600, the display illumination module 350 may determine if the video communication has ended. If at step 4600, the display illumination module 350 determines that the video communication has ended, the process may then go to step 4700 and end. Once a video communication has been determined to have ended, the display illumination module 350 may adjust the display properties of the unused portions of the display unit to the display properties that existed prior to the video communication, for example.

If at step 4600, the display illumination module 350 determines that the video communication has not ended, the process may return to step 4200. Thus, the process is iterative in that the display illumination module 350 continues to determine if the video image quality factor values do not exceed at least one threshold value and make adjustments as needed while the video communication is in progress.

Note that the display illumination module 350 may present a user interface to the user on the display unit 110 that includes selectable options for controlling the unused portions 140 of the display unit 110. In this manner, the display illumination module 350 may receive the selected options from the user from the user interface and implement the received selected options on the display unit 110. The options on the user interface may include whether to adjust the unused portions of the display unit 110, location of the unused portions to be adjusted, color of the unused portions to be adjusted, pattern of the unused portions to be adjusted, brightness of unused portions to be adjusted, etc., for example.

Embodiments within the scope of the present disclosed embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc., that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described disclosed embodiments are part of the scope of this description. For example, the principles of the disclosed embodiments may be applied to each individual user where each user may individually deploy such a system. This enables each user to utilize the benefits of the disclosed embodiments even if any one of the large number of possible applications does not need the functionality described herein. In other words, there may be multiple instances of the components of the disclosed embodiments each processing the content in various possible ways. It does not necessarily need to be one system used by all end users. Accordingly, only the appended claims and their legal equivalents should define the disclosed embodiments, rather than any specific examples given.

We claim:

1. A method for illuminating a user of a video communication device, comprising:
capturing a video image using the video communication device;
determining video image quality factor values based on the captured video image;
determining if the video image quality factor values exceed at least one threshold value, wherein if the video image quality factor values are determined not to exceed at least one threshold value,
adjusting at least one display property of at least one unused portion of the user's display based on the determined video image quality factor values and the at least one threshold value, wherein the at least one unused portion of the user's display is not being used to present images to the user; and
capturing the video image using the adjusted display properties for presentation to another party in video communication with the user.

2. The method of claim 1, further comprising:
determining if the video communication has ended, wherein if it is determined that the video communication has ended, adjusting the display properties of the unused portions of the display to display properties that existed prior to the video communication.

3. The method of claim 1, further comprising:
monitoring video image quality factor values after display adjustments are made to determine if they do not exceed at least one threshold value, wherein if the video image quality factor values are determined not to exceed at least one threshold value, adjusting at least one display property of at least one unused portion of the display based on the determined video image quality factor values and the at least one threshold value.

4. The method of claim 3, wherein the video image quality factor values are determined on a frame-by-frame basis.

5. The method of claim 1, wherein the video image quality factor values are at least one of video image average brightness, color gains, and noise level.

6. The method of claim 1, wherein the display properties of the unused portions of the video display are at least one of intensity, contrast, brightness, and color.

7. The method of claim 1, further comprising:
presenting a user interface to the user that includes selectable options concerning the unused portions of the display;
receiving selected options from the user interface; and
implementing the received selected options on the display.

8. The method of claim 7, wherein the options on the user interface are at least one of whether to adjust unused portions of the display, location of unused portions to be adjusted, color of unused portions to be adjusted, pattern of unused portions to be adjusted, and brightness of unused portions to be adjusted.

9. The method of claim 1, wherein the video communication device is one of a computer, a server, a telephone, a camera, a display, a set top box, a television, and a personal digital assistant.

10. A video communication device, comprising:
a camera that captures a video image;
an image quality module that determines video image quality factor values based on the captured video image; and
a display illumination module that determines if the video image quality factor values exceed at least one threshold value, wherein if the display illumination module determines that the video image quality factor values do not exceed at least one threshold value, the display illumination module adjusts at least one display property of at least one unused portion of a display of a user based on the determined video image quality factor values and the at least one threshold value, wherein the at least one unused portion of the user's display is not being used to present images to the user,
wherein the camera captures the video image using the adjusted display properties for presentation to another party in video communication with the user.

11. The video communication device of claim 10, wherein the display illumination module determines if the video communication has ended, wherein if the display illumination module determines that the video communication has ended, the display illumination module adjusts the display properties of the unused portions of the display to display properties that existed prior to the video communication.

12. The video communication device of claim 10, wherein the display illumination module monitors video image quality factor values after display adjustments are made to determine if they do not exceed at least one threshold value, wherein if the display illumination module determines that the video image quality factor values do not exceed at least one threshold value, the display illumination module adjusts at least one display property of at least one unused portion of the user's display based on the determined video image quality factor values and the at least one threshold value.

13. The video communication device of claim 12, wherein the display illumination module determines the video image quality factor values on a frame-by-frame basis.

14. The video communication device of claim 10, wherein the video image quality factor values are at least one of video image average brightness, color gains, and noise level.

15. The video communication device of claim 10, wherein the display properties of the unused portions of the video display are at least one of intensity, contrast, brightness, and color.

16. The video communication device of claim 10, wherein the display illumination module presents a user interface to the user on the display that includes selectable options concerning the unused portions of the display, receives the selected options from the user interface, and implements the received selected options on the display.

17. The video communication device of claim 16, wherein the options on the user interface are at least one of whether to adjust unused portions of the display, location of unused portions to be adjusted, color of unused portions to be adjusted, pattern of unused portions to be adjusted, and brightness of unused portions to be adjusted.

18. The video communication device of claim 10, wherein the video communication device is one of a computer, a server, a telephone, a camera, a display, a set top box, a television, and a personal digital assistant.

19. A video communication device, comprising:
a display that displays a video image and includes at least one unused portion that is not being used to present images to a user;
a camera coupled to the display that captures the video image in a video communication to be sent to another party;
an image quality module that determines video image quality factor values based on the captured video image; and
a display illumination module that determines if the video image quality factor values exceed at least one threshold value, wherein if the display illumination module determines that the video image quality factor values do not exceed at least one threshold value, the display illumination module adjusts at least one display property of at least one unused portion of the user's display based on the determined video image quality factor values and the at least one threshold value,
wherein the camera captures the video image using the adjusted display properties and the video image is presented to another party in video communication with the user.

20. The video communication device of claim 19, wherein the video communication device is one of a computer, a server, a telephone, a set top box, a television, and a personal digital assistant.
